(19) United States
(12) Patent Application Publication
(10) Pub. No.: US 2024/0427661 A1
(43) Pub. Date: Dec. 26, 2024

(54) LOGGING BURST ERROR INFORMATION OF A DYNAMIC RANDOM ACCESS MEMORY (DRAM) USING A BUFFER STRUCTURE AND SIGNALING

(71) Applicant: Rambus Inc., San Jose, CA (US)

(72) Inventor: Taeksang Song, San Jose, CA (US)

(21) Appl. No.: 18/707,281

(22) PCT Filed: Nov. 14, 2022
(86) PCT No.: PCT/US2022/049846

§ 371 Date: May 3, 2024

Related U.S. Application Data
(60) Provisional application No. 63/282,110, filed on Nov. 22, 2021.

(51) Int. Cl. G06F 11/10; G06F 11/14

(52) U.S. Cl. CPC G06F 11/1048; G06F 11/141

(57) ABSTRACT

Technologies for storing burst error information in a buffer structure and signaling to prevent overflow and over-writing the buffer structure are described. One controller device includes error detection logic, a buffer, and buffer control logic. The error detection logic detects an error in a read operation associated with a memory device coupled to the controller device. The buffer stores error information associated with the error. The buffer control logic generates and outputs a first signal responsive to the buffer being full.

### BACKGROUND

Modern computer systems generally include a data storage device, such as a memory component or device. The memory component may be, for example, a random access memory (RAM) device or a dynamic random access memory (DRAM) device. The memory device includes memory banks made up of memory cells that a memory controller or memory client accesses through a command interface and a data interface within the memory device. A memory controller can include an error correction code (ECC) engine that can detect an error in read data being read from a DRAM device. The ECC engine can log the error until it is analyzed by another entity. However, in some instances, such as where a wordline driver has a fault, the consecutive read response from the DRAM can contain multiple errors, referred to as burst error detections. However, an interrupt routine can take multiple clock cycles to read the error in the ECC engine, so earlier error information can be over-written by later error information, resulting in loss of error information.

### BRIEF DESCRIPTION OF THE DRAWINGS

The present disclosure is illustrated by way of example, and not by way of limitation, in the figures of the accompanying drawings.

FIG. 1A is a block diagram of a memory system with a controller and a memory device according to one implementation.

FIG. 1B is a timing diagram of multiple errors detected by an ECC engine within an error-handling time of an interrupt-handling routine according to one implementation.

FIG. 2 is a block diagram of a memory system with a memory device and a controller with a buffer structure according to at least one embodiment.

FIG. 3 is a block diagram of a controller with an ECC engine, a processor, and a buffer structure according to at least one embodiment.

FIG. 4 is a flow diagram of a method of reading burst error information from multiple entries of a first-in, first-out (FIFO) buffer according to at least one embodiment.

FIG. 5 is a block diagram of an integrated circuit with an error-reporting engine with a FIFO buffer according to at least one embodiment.

FIG. 6 is a flow diagram of a method of operating an integrated circuit for logging burst error information of a memory device according to at least one embodiment.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

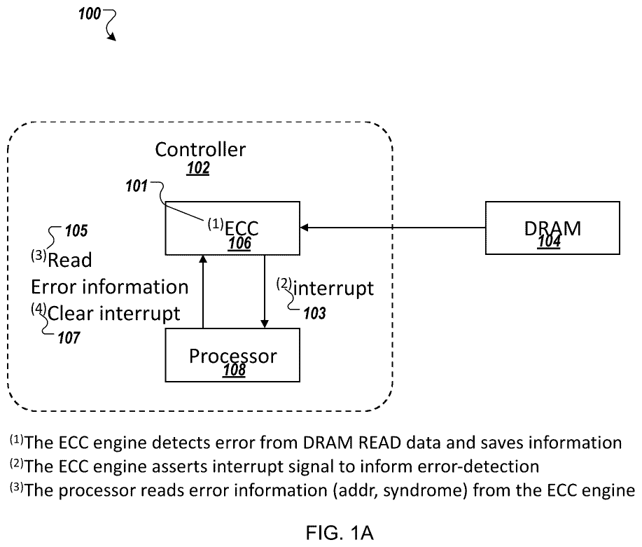

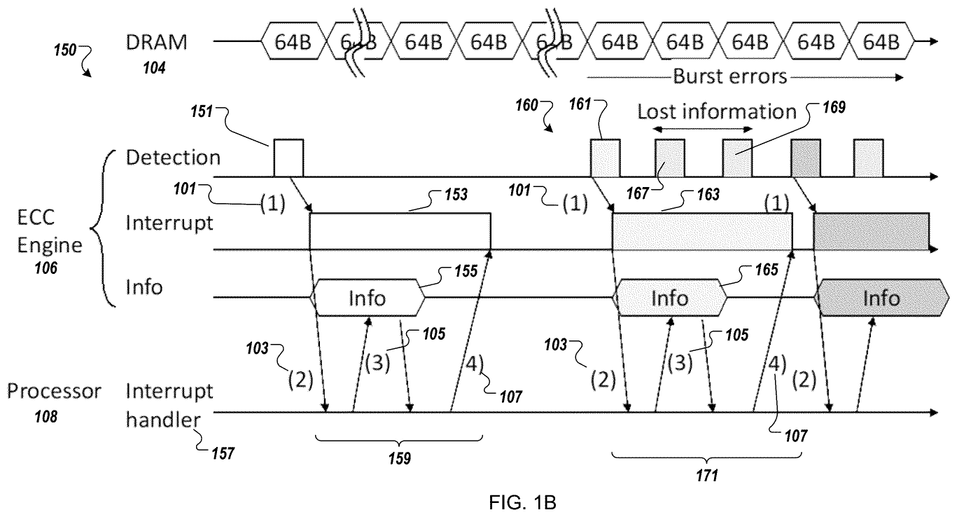

FIG. 1A is a block diagram of a memory system 100 with a controller 102 and a memory device 104 according to one implementation. The controller 102 includes an ECC engine 106 and a processor 108 (also referred to as a management processor). During operation, the ECC engine 106 can detect an error (101) in data being read from the memory device 104 (e.g., DRAM device). The ECC engine 106 can log the error until it is analyzed by the processor 108. The error can be logged in a specified register or memory location of the ECC engine 106. In response to detection of the error (101), the ECC engine 106 asserts an interrupt (103) to the processor 108 so that the processor 108 reads the saved error information from the specified register (105) and clears the interrupt once handled (107). Asserting the interrupt (103) can trigger an interrupt-handling routine on the processor 108 to read the error information from the ECC engine 106 (105) and clear the interrupt (107). The interrupt-handling routine can take multiple clock cycles, such as tens to hundreds of clock cycles, to read the error information (105) and clear the interrupt (107). Asserting the interrupt (103) can also trigger a demand scrub option to figure out the error type of the detected error. For management of the memory device 104, all error information should be logged and analyzed by the processor 108. The processor 108 can enable Post Package Repair (PPR), perform page-offlining, health monitoring, replace a faulty memory device, and/or other management processes based on the error information.

There are scenarios where multiple errors can occur in a shorter time than the time it takes the interrupt-handling routine of the processor 108 to read the error information (105) and clear the interrupt (107) before subsequent error information over-writes previous error information. The time the interrupt-handling routine takes to read the error information (105) and clear an interrupt (107) is called an error-handling time 159. Burst error detections occur when multiple error detections occur in a shorter time than the error-handling time, as illustrated in FIG. 1B.

FIG. 1B is a timing diagram 150 of multiple errors detected by an ECC engine within an error-handling time of an interrupt-handling routine according to one implementation. As described above, in response to the ECC engine 106 detecting an error 151 (101), the ECC engine 106 asserts an interrupt 153 (103) and stores error information 155. Asserting the interrupt 153 (103) triggers an interrupt-handling routine 157 to read the error information 155 (105) and clear the interrupt 153 (107). Since only one error 151 is detected within an error-handling time 159, the error information 155 can be read from the ECC engine 106 without loss of information.

However, there are scenarios where multiple errors can be detected within the error-handling time 159, as illustrated in the timing diagram 150 with the subsequent errors detected. For example, a wordline drive can have a fault that causes consecutive read responses from the memory device 104 to contain errors, resulting in burst error detections 160. In particular, the burst error detections 160 can start with a first error 161 being detected. In response to the ECC engine 106 detecting the first error 161 (101), the ECC engine 106 asserts a first interrupt 163 (103) and stores first error information 165. Asserting the first interrupt 163 (103) triggers the interrupt-handling routine 157 to read the first error information 165 (105) and clear the first interrupt 163 (107). The problem is that the interrupt-handling routine 157 takes a first error-handling time 171 to read the first error information 165 and clear the first interrupt 163 and a second error 167 and a third error 169 are detected within the first error-handling time 171. Since two errors are detected within the first error-handling time 171, the first error information 165 can be overwritten with second error information and/or third error information from the second error 167 and the third error 169, resulting in loss of error information. In some cases, the second error information of the second error 167 is read, and the first error information 165 and the third error information of the third error 169 are lost. That is, the error information from a previous error can be over-written by error information of a later error.

As shown in FIG. 1B, burst error detections caused by a wordline fault cannot be managed properly. Error detection can occur at a rate of error detection per two clock cycles, which is much shorter than the error-handling time. The error information can be over-written in which old information is lost, or overflow can occur in which new information is lost.

Aspects of the present disclosure overcome the deficiencies noted above and others by providing a buffer structure with signaling to prevent overflow and over-writing the buffer structure. The buffer structure can include a buffer, such as a first-in, first-out (FIFO) buffer and buffer control logic. The FIFO buffer can include multiple entries to save error information for multiple errors. The buffer control logic can generate and output a first signal responsive to the FIFO buffer being full to prevent overflow and over-writing. In another embodiment, the buffer control logic to output a second signal responsive to the FIFO buffer satisfying a fill condition that is less than the FIFO buffer being full. The second signal can escalate an interrupt priority if the FIFO buffer reaches a threshold level. Aspects of the present disclosure can provide various benefits, including better reliability. The buffer structure and signaling described herein can improve the reliability of memory management of a memory device by a management processor because all error information can be reported and analyzed without loss of error information. The buffer structure can efficiently handle DRAM burst error information while preventing over-writing error information or overflow of the FIFO buffer. Since all the error information is reported and analyzed, the management processes (e.g., PPR, offlining) can be reliably triggered when required for the memory device. Aspects of the present disclosure can provide signaling (e.g., a backpressure signal) to block read responses to the ECC engine and escalate an interrupt priority level to read error information before the FIFO buffer becomes full. Aspects of the present disclosure also provide a mechanism to look up a corresponding device physical address (DPA) from a returned read identifier (RID).

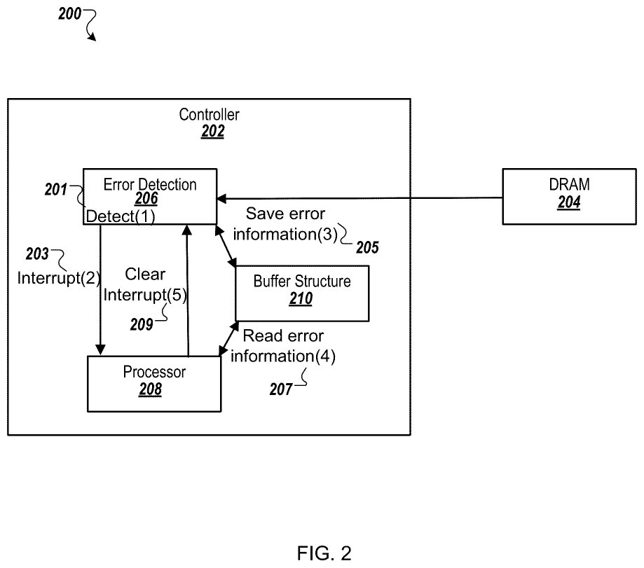

FIG. 2 is a block diagram of a memory system 200 with a memory device 204 and a controller device 202 with a buffer structure 210 according to at least one embodiment. The controller device 202 can communicate with the memory device 204 using a cache-coherent interconnect protocol (e.g., the Compute Express Link™ (CXL™) protocol. The controller device 202 can be a device that implements the CXL™ standard. The CXL™ protocol can be built upon physical and electrical interfaces of a PCI Express® standard with protocols that establish coherency, simplify the software stack, and maintain compatibility with existing standards. The controller device 202 includes an error detection logic 206 and a processor 208 (also referred to as a management processor). The controller device 202 can be part of a single-host memory expansion integrated circuit, a multi-host memory pooling integrated circuit, or the like.

In at least one embodiment, the controller device 202 includes the error detection logic 206. The error detection logic 206 can detect an error in a read operation associated with the memory device 204 coupled to the controller device 202. The error detection logic 206 can be part of an ECC engine. Alternatively, other types of error detection circuits can be used to detect errors in data read from the memory device 204. In at least one embodiment, the memory device 204 is a DRAM device.

In one embodiment, the buffer structure 210 can include a buffer to store error information associated with the error and buffer control logic to generate and output a first signal responsive to the buffer being full. The buffer can be a FIFO buffer with multiple entries. Each entry can store an identifier, a device physical address, an error type, error information. In a further embodiment, the buffer control logic can monitor the buffer and generate and send a second signal responsive to the buffer satisfying a fill condition that is less than the buffer being full (e.g., less than 5% space remaining or X number of entries remaining, or the like). In at least one embodiment, the first signal is a backpressure signal, and the second signal is an interrupt. A backpressure signal can be an indication of the buildup of data in the buffer. The backpressure signal can be sent when the buffer is full and not able to receive additional data. The backpressure signal can cause the error detection logic 206 (or ECC engine) to stop receiving read data from the memory device 204 to prevent the possibility that additional errors be detected and error information for these errors being stored in the buffer. No additional data is transferred until the buffer has been emptied or has reached a specified condition, such as a specified level of available space in the buffer.

In another embodiment, the buffer control logic can generate and output a first interrupt responsive to the buffer satisfying a first fill condition that is less than the buffer being full. The first interrupt can be associated with a first priority level. The buffer control logic can generate and output a second interrupt responsive to the buffer satisfying a second fill condition between the first fill condition and the buffer being full. The second interrupt can be associated with a second priority level that is greater than the first priority level. In this manner, the buffer control logic can escalate a priority level of the interrupts as the buffer is almost full to improve performance by preventing overflow or over-writing of the buffer.

During operation, the error detection logic 206 can detect (201) an error in read data being read from the memory device 204 (e.g., DRAM device). The error detection logic 206 can log the error until it is analyzed by the processor 208. The error detection logic 206 can save error information (205) in the buffer structure 210. The buffer structure 210 can include a buffer and buffer control logic. The buffer can be a FIFO buffer and can include multiple entries, each entry storing error information associated with each error detected by the error detection logic 206. In response to detection of the error (201), the error detection logic 206 asserts an interrupt (203) to the processor 108 so that the processor 208 reads the saved error information from the buffer structure 210 (207) and clears the interrupt once handled (209). Asserting the interrupt (203) can trigger an interrupt-handling routine on the processor 208 to read error information from the buffer structure 210 (207) and clears the interrupt (209). The interrupt-handling routine can take multiple clock cycles, such as tens to hundreds of clock cycles, to read the error information (207) and clear the interrupt (209). Asserting the interrupt (203) can also trigger a demand scrub option to figure out the error type of the detected error. For management of the memory device 204, all error information should be logged and analyzed by the processor 208. The processor 208 can enable PPR, perform page-offlining, health monitoring, replacing a faulty memory device, and/or other management processes based on the error information.

As described above, there are scenarios where multiple errors can occur in a shorter time than the time it takes the interrupt-handling routine of the processor 208 to read the error information (207) and clear the interrupt (209). However, in this scenario, subsequent error information can be written into subsequent buffer entries, preventing the subsequent error information from over-writing previous error information. The time taken by the interrupt-handling routine to read the error information (207) and clear an interrupt (209) is called an error-handling time. Burst error detections occur when multiple error detections occur in a shorter time than the error-handling time. Using the buffer structure 210, the burst error detections can be logged, read from the buffer structure 210 without losing information from over-writing or overflow, as described in more detail below.

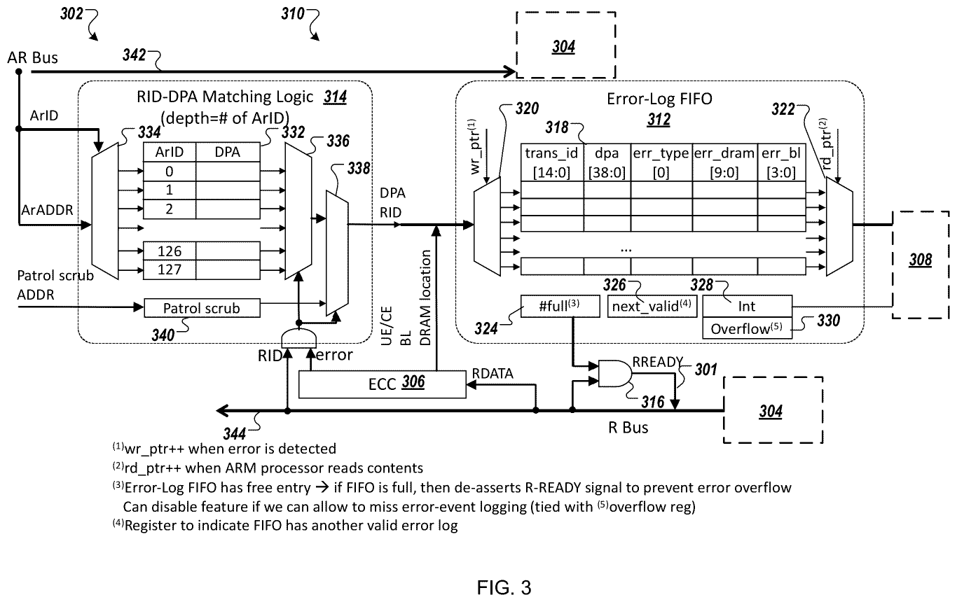

FIG. 3 is a block diagram of a controller 302 with an ECC engine 306, a processor 308, and a buffer structure 310 according to at least one embodiment. The buffer structure 310 includes an error-log FIFO structure 312 with a FIFO buffer 318 with multiple entries coupled between a multiplexer 320 and a de-multiplexer 322 and buffer control logic. The buffer control logic can include backpressure signal logic 316 and matching logic 314. Since only a request identifier (RID) is returned with the read data and not a device physical address (DPA), the matching logic 314 can match the RID with the physical address of the read operation as described in more detail below.

When an error is detected by the ECC engine 306, the matching logic 314 provides the DPA of the corresponding request using the RID-DPA mapping in the buffer 332. The ECC engine 306 can also output an error signal to the matching logic 314. The ECC engine 306 can also output, to the error-log FIFO structure 312, the error information associated with the error concurrently with the identifier and the physical address being output by the matching logic 314. The ECC engine 306 can detect multiple errors caused by a wordline fault in the memory device 304. For example, the ECC engine 306 can detect an error per every two clock cycles, which is less than an error-handling time. The RID, DPA, error type (e.g., uncorrectable error (UE) or correctable error (CE)), error location can be saved into a free entry in the FIFO buffer 318. In other embodiments, other error information can be stored in the error-log FIFO structure 312. For example, the ECC engine 306 can provide a DRAM identifier that contains the error (multi-hot coding) and a bitline (BL) location (multi-hot coding). Therefore, error-log FIFO structure 312 saves the error location information, including faulty DRAM and BL associated with the error. The error-log FIFO structure 312 can assert an interrupt signal on an interrupt pin to trigger an interrupt-handling routine of the processor 308.

In at least one embodiment, the controller 302 can be coupled to a memory device 304 with an address register bus 342 (AR bus) and a read bus 344 (R bus). The AR bus 342 can send read commands to the memory device 304, and R bus 344 can receive read data and a request identifier (RID) associated with the read data from the memory device 304. Each read command includes an identifier, such as an AR identifier (ArID), and an AR device physical address (ArADDR). In general, the read response from a memory controller does not have address information, so the matching logic 314 can save the DPA for every request from a host central processing unit (CPU). The matching logic 314 is coupled to the AR bus 342 and the R bus 344. The matching logic 314 receives the ArID and ArADDR for each read operation on the AR bus 342. The matching logic 314 can include a buffer 332 with multiple entries that store each of the ArID and ArADDR for each read operation. A multiplexer 334 can be used to select an entry where the respective ArID and ArADDR are stored in the buffer 332.

Similarly, a de-multiplexer 336 can be used to read the respective entry from the buffer 332. In at least one embodiment, a second de-multiplexer 338 can be used to select between an entry in the buffer 332 and an address provided by a patrol scrub logic 340 that operates in a scrub mode. The de-multiplexer 336 (and the second de-multiplexer 338) can be enabled by a gate that is activated by detection of an error signal received from the ECC engine 306 and a RID on the R bus 344. The matching logic 314 is coupled to the error-log FIFO structure 312. The ECC engine 306 is coupled to the R bus 344 and the error-log FIFO structure 312.

During operation, the matching logic 314 stores the identifier and associated physical address of each of the read commands sent on the AR bus 342. The ECC engine 306 receives the read data via the R bus 344. The matching logic 314 receives the respective identifier corresponding to the read data via the R bus 344 and the error signal from the ECC engine 306. The matching logic 314 locates the associated physical address of the respective identifier received from the R bus 344 and outputs the identifier and the associated physical address to the error-log FIFO structure 312 responsive to the error signal. The ECC engine 306 also outputs error information to be stored with the identifier and the associated physical address in the error-log FIFO structure 312. A write pointer can control the multiplexer 320 to store the error information, the identifier, and the physical address in a specified entry of the FIFO buffer 318. A read pointer can be used by the processor 308 to control the de-multiplexer 322 to read the specified entry in the error-log FIFO structure 312.

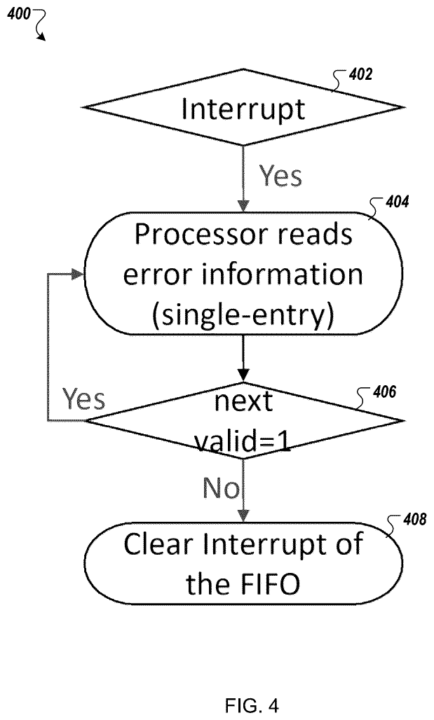

In at least one embodiment, an interrupt register 328 of the error-log FIFO structure 312 can be used to assert the interrupt signal to the processor 308. In at least one embodiment, the error-log FIFO structure 312 can send two interrupt signals, including a first interrupt signal to indicate that there is a valid entry and a second interrupt signal to indicate that a queue occupancy of the FIFO buffer 318 is over a threshold (or a threshold condition is met). In at least one embodiment, the error-log FIFO structure 312 can include a full register 324. The full register 324 can store a value to indicate that the FIFO buffer 318 has free entries. When de-asserted, a ready signal 301 of the ECC engine 306 is de-asserted. This causes no read responses to the ECC engine 306 from the memory device 304 on the R bus 344 to prevent overflow and over-writing of the entries in the FIFO buffer 318. In at least one embodiment, the error-log FIFO structure 312 can include a next valid register 326 that can store a value to indicate that the processor 308 can read multiple entries that are part of a group of errors. The next valid register 326 can indicate that the FIFO buffer 328 has another valid error log in a next entry. In general, multiple errors can occur in the read data when the controller is accessing a same row with a same physical address. In this case, the FIFO buffer 318 can store multiple error events associated with the same physical address. Instead of relying on interrupt handling per each entry, the processor 308 can read all error-event log entries until a value in the next valid register 326 indicates that it is the last entry of the group of error events (e.g., next_valid=0, instead of next_valid=1), such as illustrated in FIG. 4. In another embodiment, the error-log FIFO structure 312 can include an overflow register 330.

In at least one embodiment, the buffer control logic provides a first signal (e.g., backpressure signal or ready signal 301) via the R bus 344 responsive to the FIFO buffer 318 being full. When the overflow register 330 stores a specified value, the buffer control logic does not generate and output the first signal (e.g., backpressure signal or ready signal 301) to not block subsequent read responses on the R bus 344. If there are errors detected in the subsequent read responses, the error information associated with these errors would overflow the FIFO buffer 318 (or alternatively over-write the entries in the FIFO buffer 318).

FIG. 4 is a flow diagram of a method 400 of reading burst error information from multiple entries of a FIFO buffer according to at least one embodiment. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400 is performed by the processor 208 of FIG. 2 or the processor 308 of FIG. 3.

Referring to FIG. 4, the method 400 begins by the processing logic detecting an interrupt (block 402). In response to detecting an interrupt at block 402, the processing logic reads error information in a single entry (block 404). The processing logic checks if a value in a next valid register indicates that the FIFO buffer has another valid error log in a next entry (block 406) (e.g., next_valid=1). If the value in the next valid register indicates another valid error log, the processing logic reads error information in a next entry at block 404. The processing logic continues reading error information in the entries of the FIFO buffer until the value in the next valid register indicates that there is not another valid error log in the next entry at block 406. In response, the processing logic clears the interrupt (block 408).

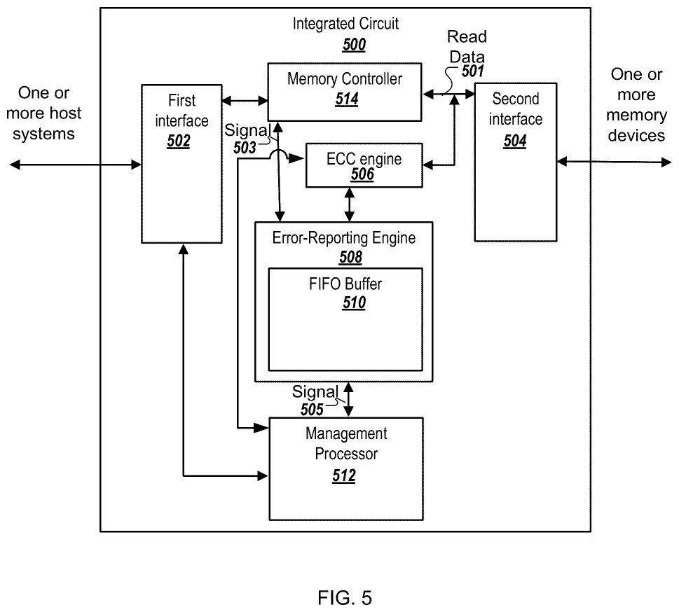

FIG. 5 is a block diagram of an integrated circuit 500 with an error-reporting engine 508 with a FIFO buffer 510 according to at least one embodiment. In at least one embodiment, the integrated circuit 500 is a memory expansion chip coupled to a single host system over a cache-coherent interconnect. In another embodiment, the integrated circuit 500 is a multi-host memory pooling chip coupled to multiple host systems over multiple cache-coherent interconnects.

In the illustrated embodiment, the integrated circuit 500 includes a first interface 502 coupled to one or more host systems (not illustrated in FIG. 5) and a second interface 504 coupled to one or more memory devices (not illustrated in FIG. 5). The integrated circuit 500 includes an ECC engine 506, the error-reporting engine 508, and a management processor 512. The ECC engine 506 can detect burst error information in data 501 read from one or more memory devices. The error-reporting engine 508 includes the FIFO buffer 510 to store the burst error information and set one or more interrupts to the management processor 512. The management processor 512 is coupled to the ECC engine 506 and the error-reporting engine 508. The management processor 512 can read the burst error information from the FIFO buffer 510 and clear the one or more interrupts. The error-reporting engine 508 can use signaling to the ECC engine 506 and the management processor 512 to prevent over-writing the burst error information or overflow in the FIFO buffer 510.

In a further embodiment, the integrated circuit 500 includes a memory controller 514. The error-reporting engine 508 can send a signal to the memory controller 514 responsive to the FIFO buffer 510 being full to prevent the over-writing or overflow in the FIFO buffer 510. In another embodiment, the memory controller 514 is coupled to the integrated circuit 500, and the error-reporting engine 508 sends the signal to the memory controller 514.

In at least one embodiment, the error-reporting engine 508 sends a first interrupt to the management processor 512 responsive to the burst error information being detected by the ECC engine 506. The error-reporting engine 508 sends a second interrupt to the management processor 512 responsive to the FIFO buffer 510 satisfying a fill condition that is less than the FIFO buffer 510 being full. The second interrupt can include a higher priority than the first interrupt.

In another embodiment, the management processor 512 includes an interrupt-handling routine to read the burst error information from the FIFO buffer 510 and clear the one or more interrupts during a first amount of time. The first amount of time can be the error-handling time of the interrupt-handling routine. In at least one embodiment, the burst error information includes error information about at least two errors detected in a second amount of time that is less than the first amount of time.

In another embodiment, the error-reporting engine 508 includes the FIFO buffer 510 with a set of entries and matching logic with a buffer to store a set of read identifiers and corresponding device physical addresses (DPAs). The error-reporting engine 508 includes buffer control logic to send a signal 503 to the memory controller 514 responsive to the FIFO buffer 510 being full to prevent the over-writing or overflow in the FIFO buffer 510. In at least one embodiment, the error-reporting engine 508 includes a first register to store a first indication that the FIFO buffer 510 is full. The first indication can be a value, a status bit, a bit, multiple bits in the first register that causes the error-reporting engine 508 to send the signal 503 to the memory controller 514. In another embodiment, the error-reporting engine 508 includes a second register to store a second indication of the one or more interrupts. The second indication can be a value, a status bit, a bit, multiple bits in the second register that causes the error-reporting engine 508 to send an interrupt signal 505 to the management processor 512.

The error-reporting engine 508 can provide a structure that can efficiently handle DRAM burst information. The error-reporting engine 508 can use an error-log FIFO module to prevent over-writing error information or prevent overflow. The error-reporting engine 508 can generate a backpressure signal to block read responses to the ECC engine 506. The error-reporting engine 508 can use a look-up table that matches corresponding DPAs using the returned request identifiers (RID) from the memory device. The error-reporting engine 508 can escalate an interrupt priority level to cause the management processor 512 to read the error information before the FIFO buffer 510 becomes full. The error-reporting engine 508 can provide more reliable memory management operations, such as PPR, offlining, or the like.

In another embodiment, the integrated circuit 500 is a processor that implements the CXL™ standard and includes matching logic and a FIFO buffer. An output of the matching logic passes through the FIFO, and a backpressure signal is generated when the FIFO buffer gets full. In a further embodiment, the processor can escalate interrupt level if the FIFO buffer reaches a threshold level or other fill conditions that are less than the FIFO buffer being full.

In at least one embodiment, in order to prevent over-writing error information caused by burst error detections within a shorter time than the interrupt-handling time, the error-log FIFO buffer (e.g., 510) of the error-reporting engine 508 is inserted between the ECC engine 506 and the management processor 512. The error-log FIFO buffer can save multiple error information before the management processor 512 reads all error information. When the entries in this FIFO buffer are over a pre-defined threshold level, the error-reporting engine 508 asserts an additional interrupt signal to indicate an urgent situation to the management processor 512. This interrupt has the highest priority, so the management processor 512 should read and invalidate the entry before overflowing or overwriting the FIFO buffer. When the error-log FIFO is full, the error-reporting engine 508 sends a backpressure signal (e.g., 503) to the memory controller 514 to hold read operations. Using this backpressure signal, all error information can be delivered to the management processor 512 without any loss of error information.

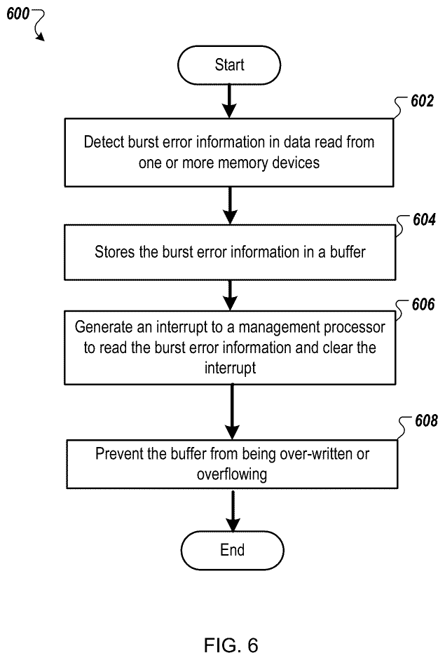

FIG. 6 is a flow diagram of a method 600 of operating an integrated circuit for logging burst error information of a memory device according to at least one embodiment. The method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 600 is performed by the controller device 202 of FIG. 2. In one embodiment, the method 600 is performed by the buffer structure 310 of FIG. 3. In one embodiment, the method 600 is performed by buffer control logic as described herein.

Referring to FIG. 6, the method 600 begins by the processing logic detecting burst error information in data read from one or more memory devices (block 602). The burst error information includes error information about at least two errors detected in a first amount of time. The processing logic stores the burst error information in a buffer (block 604). The processing logic generates an interrupt to a management processor to read the burst error information and clear the interrupt (block 606). The management processor reads the burst error information and clears the interrupt within a second amount of time (an interrupt-handling time or an error-handling time), the second amount of time being greater than the first amount of time. The processing logic prevents the buffer from being over-written or overflowing (block 608), and the method 600 returns to block 602 or ends.

In at least one embodiment, the processing logic at block 608 prevents the buffer from being over-written or overflowing by sending a signal to a memory controller responsive to the buffer being full. In another embodiment, the processing logic at block 608 prevents the buffer from being over-written or overflowing by: sending a signal to a memory controller responsive to the buffer being full; sending a first interrupt to the management processor responsive to the burst error information being detected; and sending a second interrupt to the management processor responsive to the buffer satisfying a fill condition that is less than the buffer being full, wherein the second interrupt comprises a higher priority than the first interrupt.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

What is claimed is:

1. A controller device comprising:
error detection logic to detect an error in a read operation associated with a memory device coupled to the controller device;
a buffer to store error information associated with the error; and
buffer control logic to generate and output a first signal responsive to the buffer being full.

2. The controller device of claim 1, wherein the buffer control logic is to generate and output a second signal responsive to the buffer satisfying a fill condition that is less than the buffer being full.

3. The controller device of claim 2, wherein the first signal is a backpressure signal and the second signal is an interrupt.

4. The controller device of claim 1, wherein the buffer control logic is to:
generate and output a first interrupt responsive to the buffer satisfying a first fill condition that is less than the buffer being full, wherein the first interrupt is associated with a first priority level; and
generate and output a second interrupt responsive to the buffer satisfying a second fill condition that is between the first fill condition and the buffer being full, and wherein the second interrupt is associated with a second priority level greater than the first priority level.

5. The controller device of claim 1, wherein the buffer is a first-in, first-out (FIFO) buffer.

6. The controller device of claim 1, wherein the controller device communicates with the memory device using a cache-coherent interconnect protocol.

7. The controller device of claim 1, further comprising matching logic to output, to the buffer, an identifier of the read operation, and a physical address of the read operation, wherein the error detection logic is an error correction code (ECC) engine, wherein the ECC engine is to:
detect the error from read data;
output an error signal to the matching logic; and
output, to the buffer, the error information associated with the error concurrently with the identifier and the physical address being output by the matching logic.

8. The controller device of claim 7, further comprising:
address register (AR) bus coupled to the matching logic, the AR bus to send read commands to the memory device, each read command comprising an identifier and an associated physical address; and
a read bus coupled to the matching logic, the ECC engine, and the buffer control logic, the read bus to receive, from the memory device, read data and the associated identifier, wherein:
the matching logic is to store the identifier and associated physical address of each of the read commands sent on the bus;
the ECC engine is to receive the read data via the read bus;
the matching logic is to receive the respective identifier corresponding to the read data via the read bus and the error signal from the ECC engine;
the matching logic is to locate the associated physical address of the respective identifier received from the read bus and output the identifier and the associated physical address to the buffer responsive to the error signal; and
the buffer control logic is to provide the first signal via the read bus responsive to the buffer being full.

9. The controller device of claim 1, wherein the error detection logic is to detect a plurality of errors caused by a wordline fault in the memory device.

10. An integrated circuit comprising:
a first interface coupled to one or more host systems;
a second interface coupled to one or more memory devices;
an error correction code (ECC) engine to detect burst error information in data read from the one or more memory devices;
an error-reporting engine comprising a first-in, first-out (FIFO) buffer coupled to the ECC engine to store the burst error information and set one or more interrupts; and
a management processor coupled to the ECC engine and the error-reporting engine, the management processor to read the burst error information from the FIFO buffer and clear the one or more interrupts, wherein the error-reporting engine is to prevent over-writing the burst error information or overflow in the FIFO buffer.

11. The integrated circuit of claim 10, further comprising a memory controller, wherein the error-reporting engine is to send a signal to the memory controller responsive to the FIFO buffer being full to prevent the over-writing or overflow in the FIFO buffer.

12. The integrated circuit of claim 11, wherein the error-reporting engine is further to:
send a first interrupt to the management processor responsive to the burst error information being detected by the ECC engine; and
send a second interrupt to the management processor responsive to the FIFO buffer satisfying a fill condition that is less than the FIFO buffer being full, wherein the second interrupt comprises a higher priority than the first interrupt.

13. The integrated circuit of claim 10, wherein the management processor comprises an interrupt-handling routine to read the burst error information from the FIFO buffer and clear the one or more interrupts during a first amount of time, wherein the burst error information comprises error information about at least two errors detected in a second amount of time that is less than the first amount of time.

14. The integrated circuit of claim 10, wherein the integrated circuit is a memory expansion chip coupled to a single host system over a cache-coherent interconnect.

15. The integrated circuit of claim 10, wherein the integrated circuit is a multi-host memory pooling chip coupled to a plurality of host systems over multiple cache-coherent interconnects.

16. The integrated circuit of claim 10, further comprising a memory controller, wherein the error-reporting engine comprises:
the FIFO buffer comprising a set of entries;
matching logic comprising a buffer to store a set of read identifiers and corresponding device physical addresses (DPAs); and
buffer control logic to send a signal to the memory controller responsive to the FIFO buffer being full to prevent the over-writing or overflow in the FIFO buffer.

17. The integrated circuit of claim 10, wherein the error-reporting engine comprises:
a first register to store a first indication that the FIFO buffer is full; and
a second register to store a second indication of the one or more interrupts.

18. A method of an integrated circuit, the method comprising:
detecting burst error information in data read from one or more memory devices, wherein the burst error information comprises error information about at least two errors detected in a first amount of time;
storing the burst error information in a buffer;
generating an interrupt to a management processor to read the burst error information and clear the interrupt within a second amount of time, the second amount of time being greater than the first amount of time; and
preventing the buffer from being over-written or overflowing.

19. The method of claim 18, wherein preventing the buffer from being over-written or overflowing comprises sending a signal to a memory controller responsive to the buffer being full.

20. The method of claim 18, wherein preventing the buffer from being over-written or overflowing comprises
sending a signal to a memory controller responsive to the buffer being full;
sending a first interrupt to the management processor responsive to the burst error information being detected; and
sending a second interrupt to the management processor responsive to the buffer satisfying a fill condition that is less than the buffer being full, wherein the second interrupt comprises a higher priority than the first interrupt.
